(19) United States
(12) Patent Application Publication
(10) Pub. No.: US 2010/0192461 A1
(43) Pub. Date: Aug. 5, 2010

(54) Stacked Tray Container Seedling Apparatus

(76) Inventor: Ran-Lan SHIEH, Hsinchu City (TW)

Correspondence Address: Jackson Intellectual Property Group PLLC, 106 Starvale Lane, Shipman, VA, 22971, US

(21) Appl. No.: 12/189,176

(22) Filed: Aug. 10, 2008

(51) Int. Cl. A01G 9/02

(52) U.S. Cl. 47/65.9

(57) ABSTRACT

The present invention discloses a stacked tray container seedling apparatus formed by at least two identical tray containers, and each tray container has cells and through holes arranged alternately and regularly with each other. The cells of a tray container are stacked onto the through holes of another tray container respectively for a central management or transportation of all stacked tray containers, such that seedlings in the tray container together with the tray container can be moved directly to a cultivated area for cultivations. The cell includes one or more positions higher than the through hole at the bottom of the cell for storing an appropriate quantity of water for a better growth of vegetables.

### BACKGROUND OF THE INVENTION

(a) Field of the Invention

The present invention relates to a seedling apparatus, and more particularly to a stacked tray container seedling apparatus that uses a tray container as a unit to facilitate a central management of seedlings or transplanting an entire unit of seedlings to a cultivated land, and storing an appropriate quantity of water for a better growth of vegetables.

(b) Description of the Related Art

In recent years, our economic structure is changed, and the agricultural production is encountering all kinds of problems including insufficient labor, increased wage and too-small business scale, and thus the production cost cannot be lowered. Since our living standard is improved, the labor for agricultural productions is divided professionally, and farmers have increasingly higher demands on seedling transplants, the seedlings are essential to automated agricultural productions.

Since the tray container seedling technology has the advantages of saving seeds, providing a consistent growth of seedlings, minimizing pests and diseases, giving a high survival rate of transplants, and permitting early harvests, therefore increasingly more farmers purchase tray container seedlings from seedling centers, and the automated seedling production is developed rapidly. With reference to FIGS. 1 and 2, two types of tray container assemblies generally used in the field of tray container seedling technology are illustrated.

The two conventional tray containers 81 have a plurality of cells 82 of a specific height and disposed on the trays of specific appearance and size, and the cells 82 are arranged and provided for transplanting a plurality of seedlings 90 in small pots (as shown in FIG. 1) or planting seeds directly into the cells 82 for germinating the seedlings 90 in the cells 82 (as shown in FIG. 2). Such arrangement facilitates transplanting the seedlings 90 to a cultivated area for their cultivation after the seedlings 90 grow to a certain level.

Basically, the size and interval of the cells in the tray containers will affect the quantity of seedlings directly. For example, the number of cells can be increased by decreasing the interval of cells in the tray containers of the same size, and more seedlings can be cultivated accordingly. The cells of most conventional tray containers are usually designed and arranged in a chess-shape, such that the latitude and longitude of the cells can be arranged densely to achieve the effects of reducing the interval of cells as well as increasing the number of cells in a tray container or permitting more seedlings. However, the decreased interval of cells affects the production of seedlings and causes an unmatched condition with the expected interval of seedlings in the tray container when the seedlings are transplanted to the cultivated area, and thus it is necessary to move the seedlings one by one from the tray container to the cultivated area. Such arrangement causes tremendous trouble to the management and the transplant of the seedlings.

With reference to FIG. 3, a drainage hole 83 is disposed at the bottom of each cell 82 to prevent excessive water from being accumulated in the cell 82 when the vegetable seedlings are watered, so as to prevent death, pest or diseases of the vegetable seedlings. An appropriate quantity of water for the vegetable seedlings can be maintained only at the time when the seedlings are watered, but the seedlings must be watered again from time to time, and thus it wastes much time and efforts.

If it is necessary to transport the vegetable seedlings for a longer distance, cartons are generally used for the transportation, and thus the vegetable seedlings cannot be too wet, or else the cartons will be broken or damaged easily. If the tray container 81 does not come with a drainage hole 83, then the aforementioned problem will be solved automatically. However, excessive water in the cell 82 will kill the seedlings or cause pests and diseases of the seedlings, but insufficient water will dry up the vegetable seedlings and incur losses during long-distance transportations. Otherwise, the seedlings must be watered from time to time to maintain the moisture for the seedling, and thus causing tremendous inconvenience.

### SUMMARY OF THE INVENTION

It is a primary objective of the present invention to overcome the shortcomings of the prior art by providing a convenient stacked tray container seedling apparatus for a central management of seedlings, and transplanting an entire unit of seedlings directly to a cultivated area.

To achieve the foregoing objective, the present invention provides a set of stacked tray container seedling apparatus comprising two identical tray containers, and each tray container includes a plurality of cells and through holes arranged alternately and regularly with each other, wherein the cells of a tray container are stacked on the through holes of another tray container respectively, or the stacked tray container seedling apparatus comprises at least two corresponding tray containers, and the cells between the tray containers are arranged alternately with each other, and the through holes disposed between the cells of each tray container are corresponsive to the cells of other tray containers respectively. In other words, the positions of the cells between the tray containers will not be overlapped, and the cells can be passed into the corresponding through holes.

Each set of stacked tray container seedling apparatus can use the cells of each tray container for planting the seedlings, and all tray containers can be stacked with each other for a central management or transportation. After the seedlings grow to a certain level, the seedlings together with the tray container are transplanted to a cultivated area for the cultivation of the seedlings.

Further, the cells have one or more through holes disposed at a position higher than the bottom of the cell, and each cell can contain one vegetable seedling. With the height difference between the through hole and the bottom of the cell, a storage space is defined for storing an appropriate quantity of water at the bottom of the cell.

Compared with the prior art, the present invention has the following effects:

1. Each set of stacked tray container seedling apparatus provides a planar space for arranging a number of cells evenly in a plurality of tray containers, so that the interval of seedlings in each tray container can be increased significantly to provide a better growing space for the seedlings.

2. The interval of the cells in each tray container can meet the requirements for the growth of seedlings after the seedlings are transplanted to the cultivated area and facilitate the cultivation of the transplanted seedlings.

3. The entire unit of seedlings can be transplanted directly to the cultivated area, and thus improving the production capacity of the seedling and the transplant operation greatly.

4. All tray containers are stacked with each other to facilitate a central management or transportation.

5. An appropriate quantity of water can be stored at the bottom of the cells to achieve the effects of providing a better growth of vegetables, reducing the number of times of watering, and facilitating long-distance transportations.

### BRIEF DESCRIPTION OF THE DRAWINGS

FIG. 1 is a schematic view of an application of a conventional tray container;

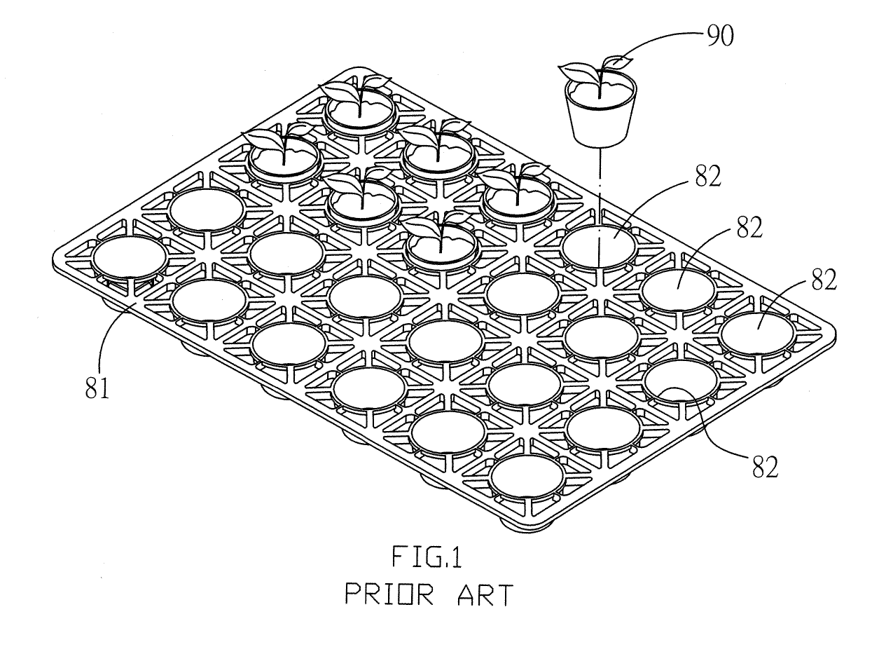

FIG. 2 is a schematic view of another application of a conventional tray container;

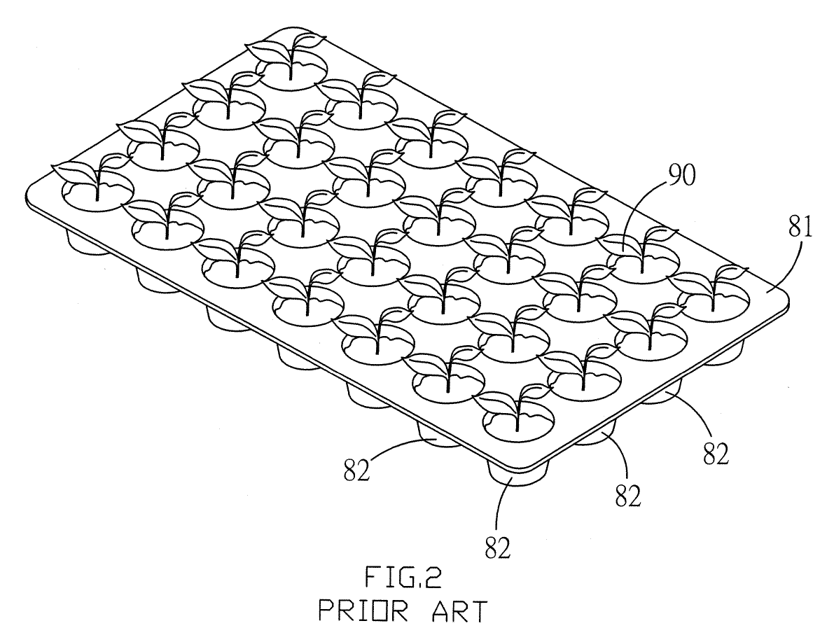

FIG. 3 is a schematic view of a conventional cell structure;

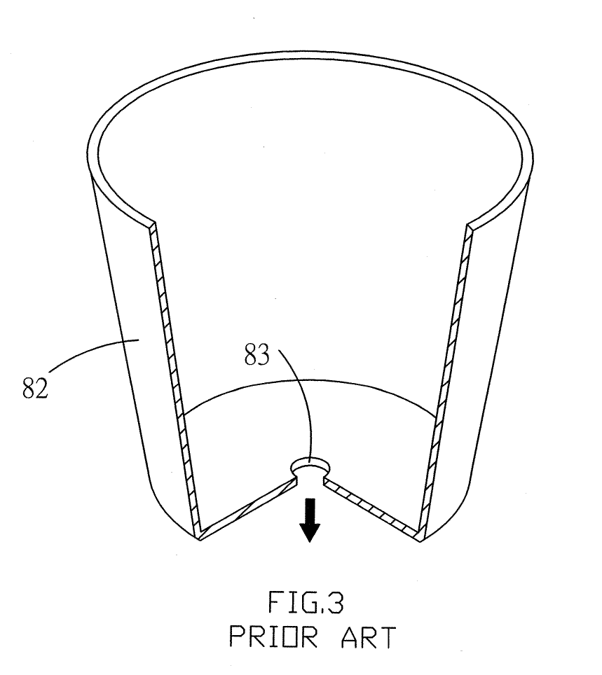

FIG. 4 is a structural exploded view of a seedling apparatus assembly in accordance with a first preferred embodiment of the present invention;

FIG. 5 is a schematic view of a stacked tray container seedling apparatus in accordance with a first preferred embodiment of the present invention;

FIG. 6 is a structural exploded view of a seedling apparatus in accordance with a second preferred embodiment of the present invention;

FIG. 7 is a structural exploded view of a seedling apparatus in accordance with a second preferred embodiment of the present invention;

FIG. 8 is a schematic view of a stacked tray container seedling apparatus in accordance with a second preferred embodiment of the present invention;

FIG. 9 is a schematic view of moving a tray container seedling apparatus in accordance with a second preferred embodiment of the present invention;

FIG. 10 is an exploded view of a seedling apparatus assembly in accordance with a third preferred embodiment of the present invention;

FIG. 11 is an exploded view of a seedling apparatus assembly in accordance with a fourth preferred embodiment of the present invention;

FIG. 12 is an exploded view of a seedling apparatus assembly in accordance with a fifth preferred embodiment of the present invention;

FIG. 13 is an exploded view of a stacked tray container seedling apparatus in accordance with a fifth preferred embodiment of the present invention;

FIG. 14 is an exploded view of a seedling apparatus assembly in accordance with a sixth preferred embodiment of the present invention;

FIG. 15 is a first schematic view of a cell structure in accordance with the present invention;

FIG. 16 is a second schematic view of a cell structure in accordance with the present invention;

FIG. 17 is a third schematic view of a cell structure in accordance with the present invention;

FIG. 18 is a fourth schematic view of a cell structure in accordance with the present invention; and

FIG. 19 is a fifth schematic view of a cell structure in accordance with the present invention.

### DETAILED DESCRIPTION OF THE PREFERRED EMBODIMENTS

The above and other objects, features and advantages of the present invention will become apparent from the following detailed description taken with the accompanying drawing.

The present invention discloses a stacked tray container seedling apparatus which is an apparatus used in the tray container seedling technology for containing seedlings, facilitating a central management of the seedlings, and transplanting an entire unit of seedlings directly to a cultivated area. Two preferred embodiments are provided for illustrating the present invention as follows:

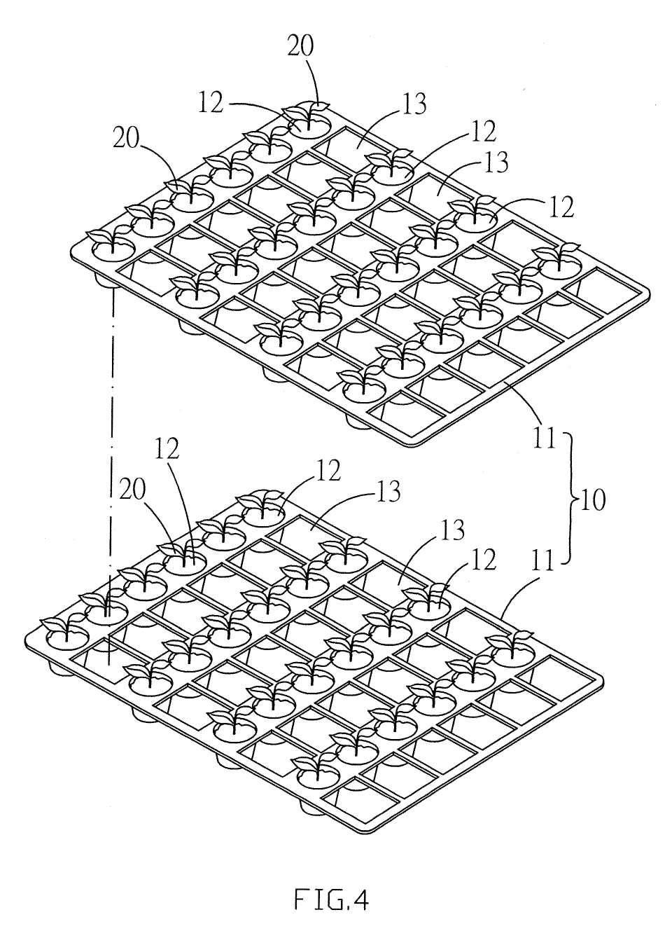

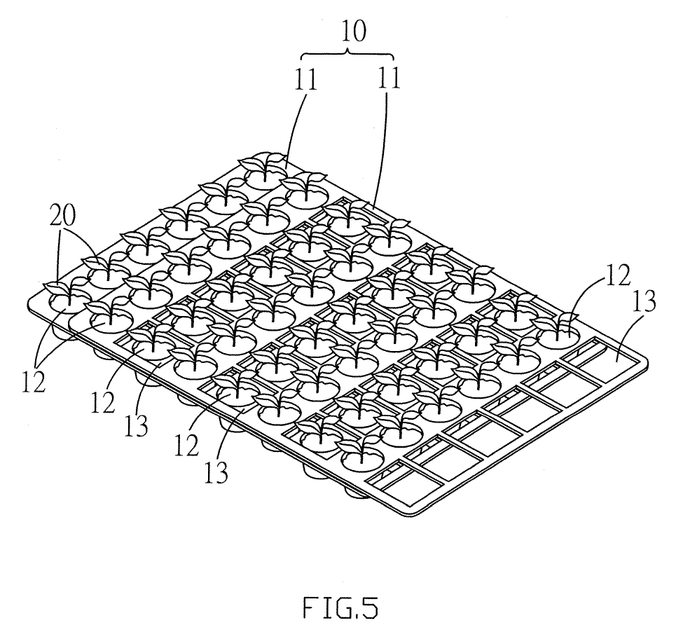

With reference to FIG. 4 for the first preferred embodiment of the present invention, an entire seedling apparatus 10 uses a tray container 11 as a unit, and comprises at least two identical tray containers 11, wherein each tray container 11 includes a plurality of cells 12 and through holes 13 arranged alternately and regularly on the tray container 11. With reference to FIG. 5 together, the cells 12 of a tray container 11 are stacked onto the through holes 13 of another tray container 11 respectively.

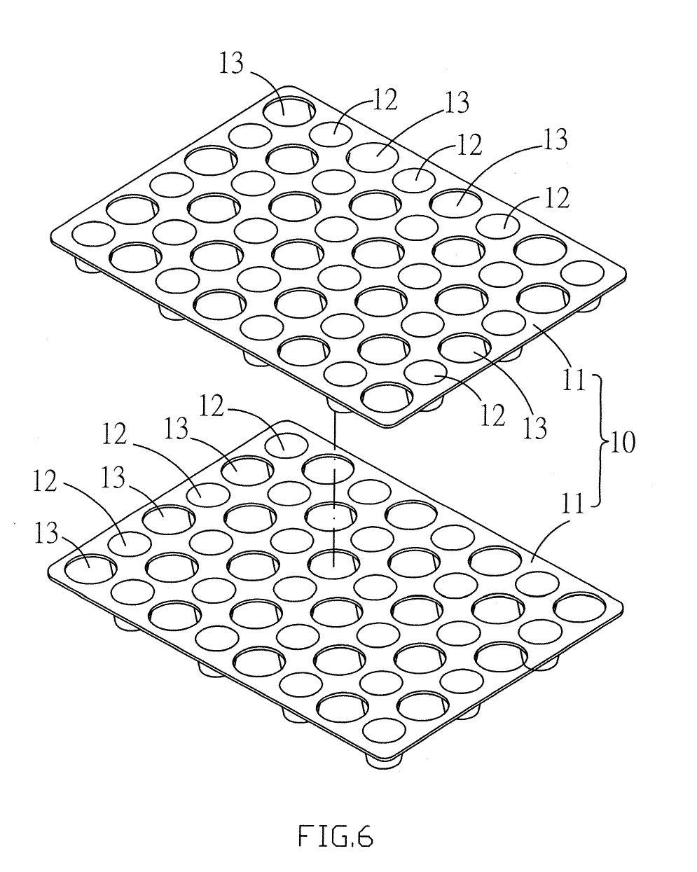

With reference to FIG. 6 for the second preferred embodiment of the present invention, the entire seedling apparatus 10 uses a tray container 11 as a unit and comprises at least two tray containers 11, wherein the cells 12 disposed between the tray containers 11 are arranged alternately with each other, and each tray container 11 includes the through holes 13 disposed between the cells 12 and corresponding to the cells 12 of the tray container 11 respectively, such that the positions of the cells 12 in each tray container 11 will not be overlapped, and the cells 12 can be passed into the corresponding through holes 13 of the other tray container 11 respectively.

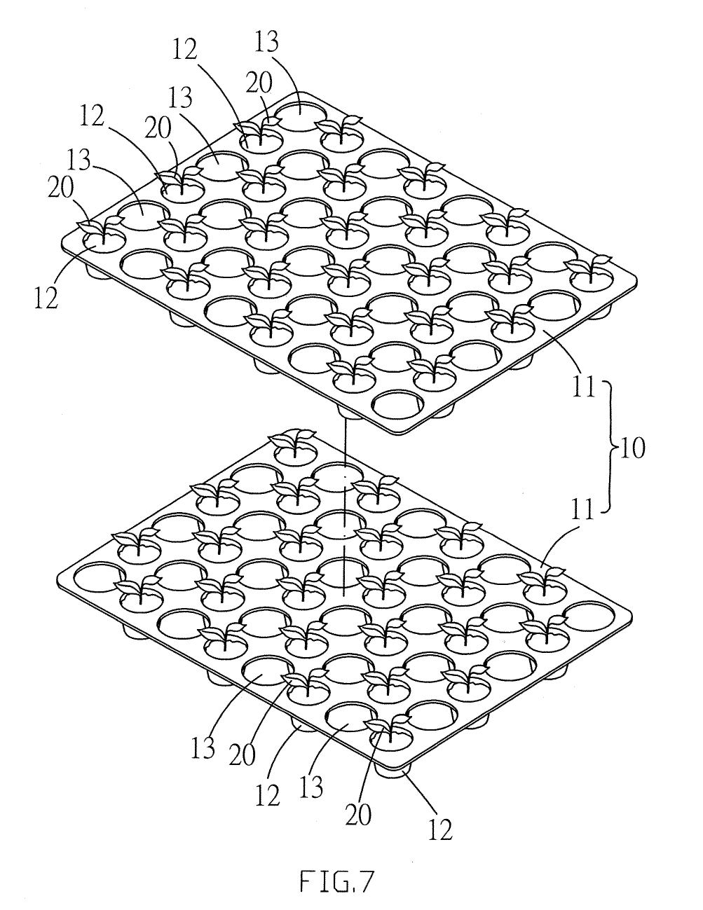

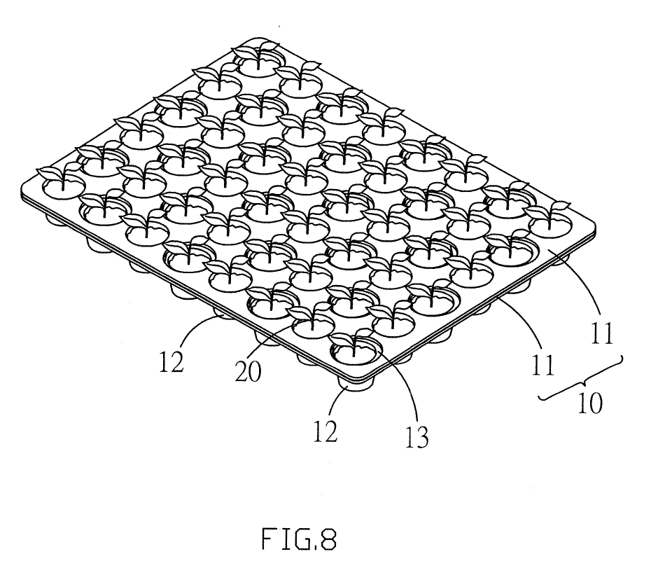

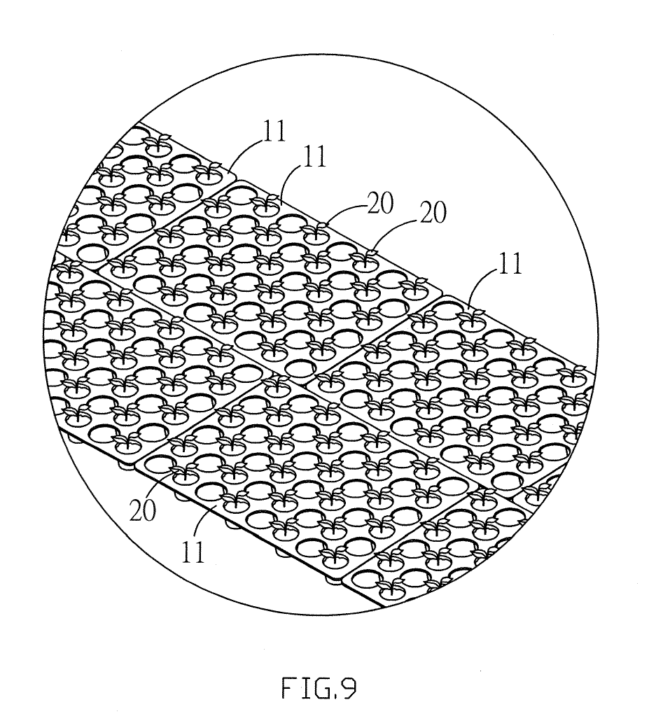

In FIG. 7, each set of seedling apparatus 10 uses the cells 12 of each tray container 11 for planting the seedlings 20. All tray containers 11 can be stacked with each other for a central management or transportation as shown in FIG. 8. After the seedlings 20 grow to a specific level, each seedling 20 in the tray container 11 together with the tray container 11 can be transplanted directly to a cultivated area for the cultivation of the seedlings 20 as shown in FIG. 9.

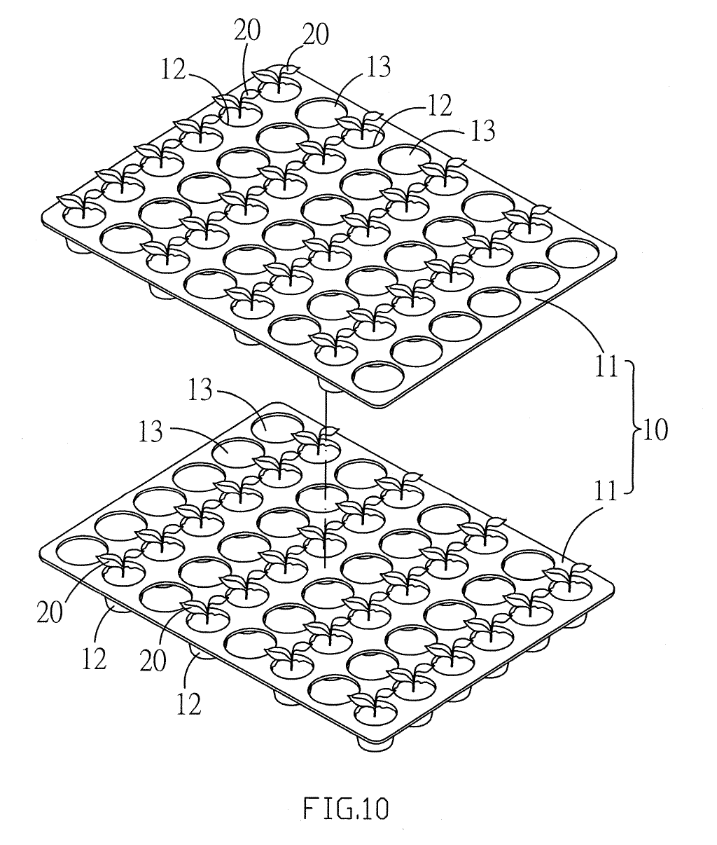

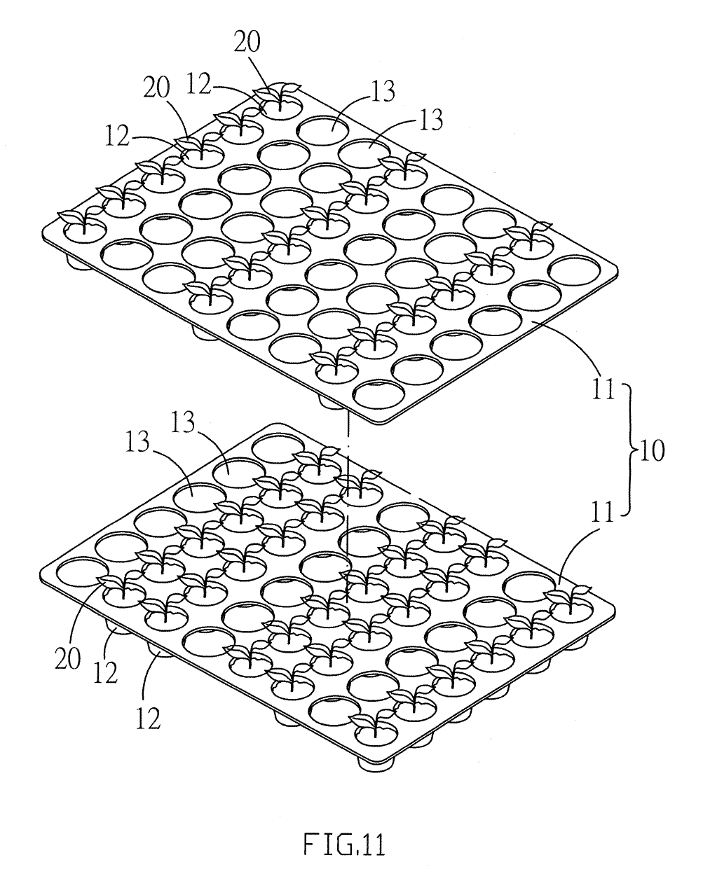

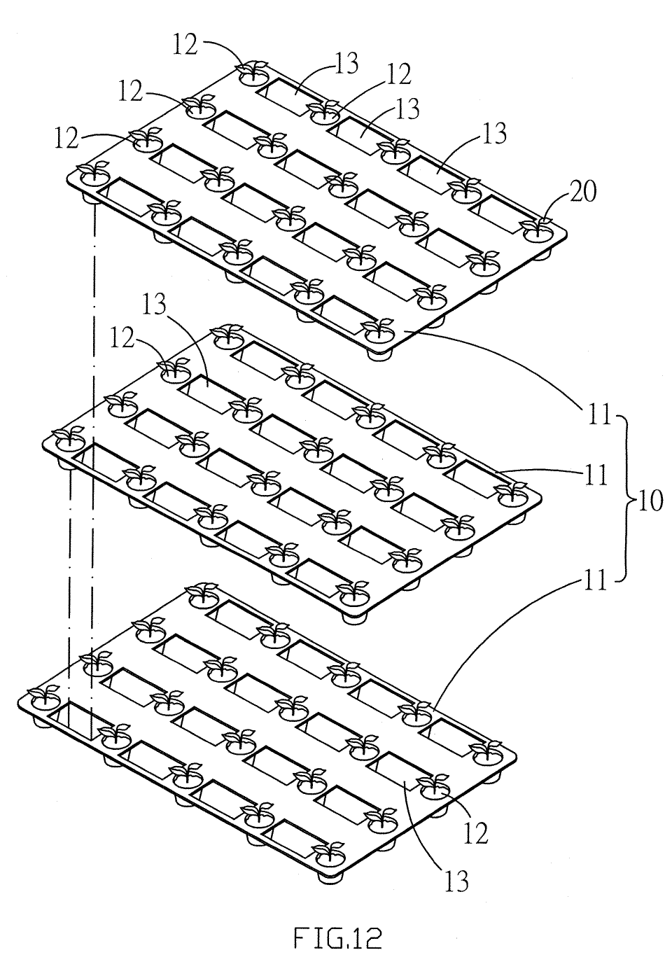

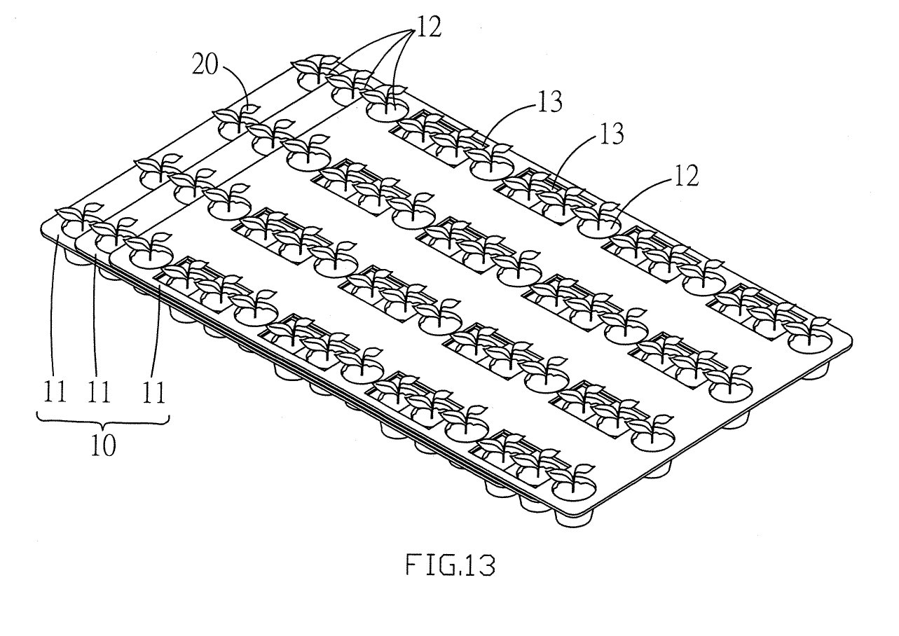

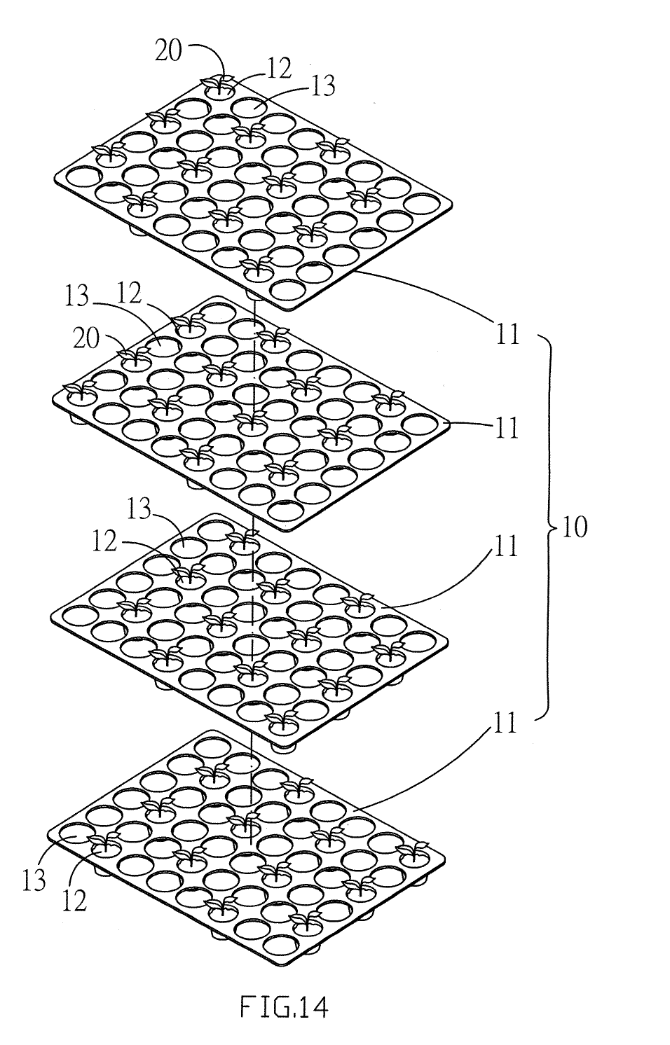

In the second preferred embodiment as shown in FIGS. 6 to 9, each set of seedling apparatus 10 comprises two tray containers 11, and the cells 12 in the two tray containers 11 are arranged alternately in a form of single cells 12. The cells 12 of the seedling apparatus 10 comprised of two tray containers 11 can be arranged alternately with each other in a form of single cells as shown in FIGS. 4 and 10, or arranged alternately in a row of cells 12 corresponding to two rows of cells 12 as shown in FIG. 11, or each set of seedling apparatus 10 comprises three tray containers 11 as shown in FIGS. 12 and 13, and the cells 12 in the three tray containers 11 are arranged alternately with each other and corresponding to two rows of cells 12. Each seedling apparatus 10 may even comprise four tray containers 11 as shown in FIG. 14, and the cells 12 in the four tray container 11 are arranged alternately and individually in a single row.

The quantity of tray containers and the arrangement of cells of each type of the seedling apparatuses primarily provide a planar space for arranging the cells evenly in a plurality of tray containers to increase the interval of seedlings of each tray container substantially, such that the seedlings can have a better growing space, and the interval of seedlings in each tray container can even meet the requirement for growing the transplanted seedlings in the cultivated area to facilitate the cultivation of the transplanted seedlings, and can transplant an entire unit of seedlings directly to a cultivated area for improving the production capacity of the transplanted seedlings.

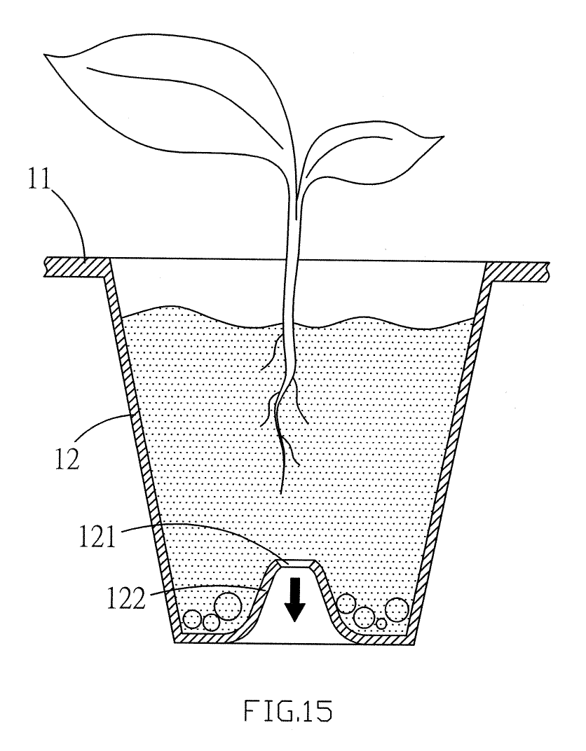

The cell 12 further includes a hole 121 disposed higher than the bottom of the cell 12 as shown in FIG. 15, and a hollow protrusion 122 extended upward towards the middle of the bottom of the cell 12, and the hole 121 is disposed at the top surface of the hollow protrusion 122, such that the height difference between the hole 121 and the bottom of the cell 12 defines a storage space for storing an appropriate quantity of water at the bottom of the cell 12 for a better growth of vegetables, a decreased number of times of watering, and a convenient long-distance transportation. The storage space defined by the height difference can maintain a high level of moisture for the vegetables and drain excessive water, while preventing the vegetables from being dried up or the roots from being rotten by excessive water.

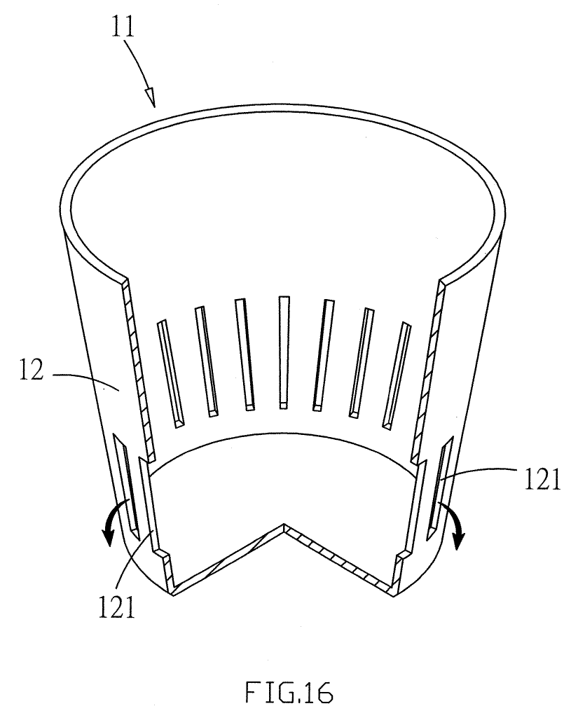

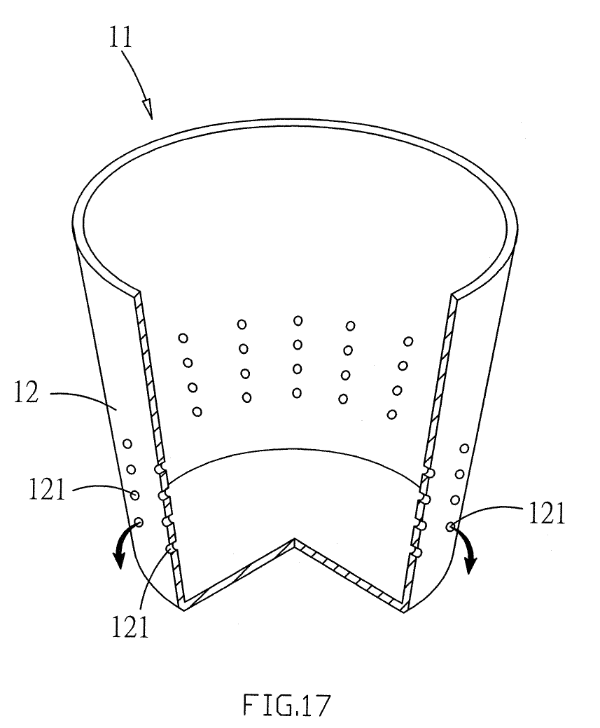

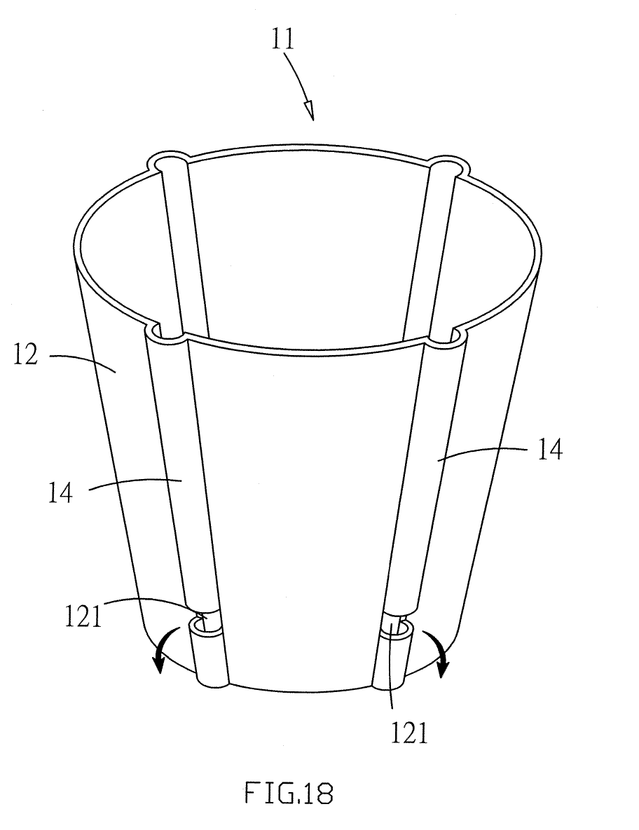

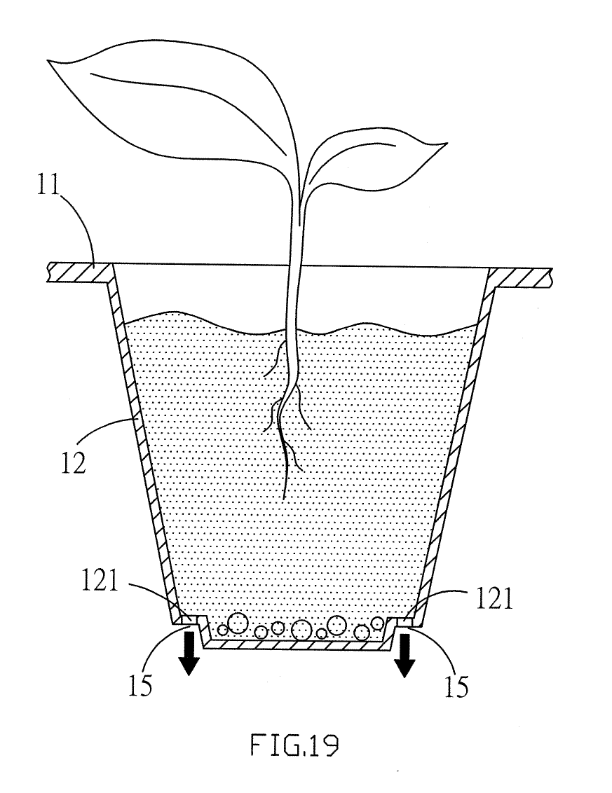

In FIG. 16, the hole 121 is disposed on a sidewall of the cell 12, and each hole 121 is in a rectangular bar shape and disposed perpendicular to the bottom of the cell 12. The hole 121 can be in a circular shape as shown in FIG. 17, or the sidewall of the cell 12 includes a plurality of ribs 14 as shown in FIG. 18, and the plurality of ribs 14 are disposed perpendicular to the bottom of the cell 12, and the hole 121 can be disposed on each rib 14. The height difference between the through hole and the bottom of the cell 12 can be changed according to the requirements for cultivating different vegetables to adjust the quantity of water stored in the storage space in compliance with the properties of different vegetables. In FIG. 19, an inwardly bent portion 15 is integrally formed on the sidewall of the cell 12 and proximate to the bottom of the sidewall, and the hole 121 is disposed at the top surface of the inwardly bent portion 15 for forming the height difference between the hole 121 and the bottom of the cell 12 to define a storage space for storing water similarly.

While the invention has been described by means of specific embodiments, numerous modifications and variations could be made thereto by those skilled in the art without departing from the scope and spirit of the invention set forth in the claims.

I claim:

1. A stacked tray container seedling apparatus, comprising at least two identical tray containers, and each tray container having a plurality of cells and through holes arranged alternately and regularly with each other, and the cells of a tray container being stacked on the through holes of another tray container respectively, and each cell having one or more positions higher than a hole disposed at the bottom of the cell.

2. The stacked tray container seedling apparatus of claim 1, wherein each set of stacked tray container seedling apparatus comprises two tray containers, and the cells of the two tray container are arranged alternately with each other in a form of single cells.

3. The stacked tray container seedling apparatus of claim 1, wherein each set of stacked tray container seedling apparatus comprises two tray containers, and the cells of the two tray containers are arranged alternately with each other in a form of a single row of cells.

4. The stacked tray container seedling apparatus of claim 1, wherein each set of stacked tray container seedling apparatus comprises two tray containers, and the cells of the two tray containers are arranged alternately with each other in a form of a single row of cells corresponding to two rows of cells.

5. The stacked tray container seedling apparatus of claim 1, wherein each set of stacked tray container seedling apparatus comprises three tray containers, and the cells of the three tray containers are arranged alternately with each other and individually corresponding to two rows of cells.

6. The stacked tray container seedling apparatus of claim 1, wherein each set of stacked tray container seedling apparatus comprises four tray containers, and the cells of the four tray containers are arranged alternately with each other and individually in a single row.

7. The stacked tray container seedling apparatus of claim 1, further comprising a hollow protrusion extended upward from the middle of the bottom of the cell, and the hole being disposed at the top surface of the hollow protrusion.

8. The stacked tray container seedling apparatus of claim 1, wherein the hole is disposed on a sidewall of the cell.

9. The stacked tray container seedling apparatus of claim 1, further comprising a plurality of ribs disposed on the sidewall of the cell and perpendicular to the bottom of the cell, and the hole is disposed on each rib.

10. The stacked tray container seedling apparatus of claim 1, further comprising an inwardly bent portion integrally formed on the sidewall of the cell and proximate to the bottom of the sidewall, and the hole is disposed on the top surface of the inwardly bent portion.

11. A stacked tray container seedling apparatus, comprising at least two identical tray containers, a plurality of cells arranged alternately between the tray containers, and a plurality of through holes disposed between the cells of each tray container and corresponding to the cells of another tray container respectively, and the cell including one or more positions higher than a hole at the bottom of the cell.

12. The stacked tray container seedling apparatus of claim 11, wherein each set of stacked tray container seedling apparatus comprises two tray containers, and the cells of the two tray container are arranged alternately with each other in a form of single cells.

13. The stacked tray container seedling apparatus of claim 11, wherein each set of stacked tray container seedling apparatus comprises two tray containers, and the cells of the two tray containers are arranged alternately with each other in a form of a single row of cells.

14. The stacked tray container seedling apparatus of claim 11, wherein each set of stacked tray container seedling apparatus comprises two tray containers, and the cells of the two tray containers are arranged alternately with each other in a form of a single row of cells corresponding to two rows of cells.

15. The stacked tray container seedling apparatus of claim 11, wherein each set of stacked tray container seedling apparatus comprises three tray containers, and the cells of the three tray containers are arranged alternately with each other and individually corresponding to two rows of cells.

16. The stacked tray container seedling apparatus of claim 11, wherein each set of stacked tray container seedling apparatus comprises four tray containers, and the cells of the four tray containers are arranged alternately with each other and individually in a single row.

17. The stacked tray container seedling apparatus of claim 11, further comprising a hollow protrusion extended upward from the middle of the bottom of the cell, and the hole being disposed at the top surface of the hollow protrusion.

18. The stacked tray container seedling apparatus of claim 11, wherein the hole is disposed on a sidewall of the cell.

19. The stacked tray container seedling apparatus of claim 11, further comprising a plurality of ribs disposed on the sidewall of the cell and perpendicular to the bottom of the cell, and the hole is disposed on each rib.

20. The stacked tray container seedling apparatus of claim 11, further comprising an inwardly bent portion integrally formed on the sidewall of the cell and proximate to the bottom of the sidewall, and the hole is disposed on the top surface of the inwardly bent portion.
